(19) United States
(12) Patent Application Publication
(10) Pub. No.: US 2014/0185437 A1
(43) Pub. Date: Jul. 3, 2014

(54) METHODS AND ARRANGEMENTS FOR TRAFFIC INDICATION MAPPING IN WIRELESS NETWORKS

(71) Applicant: Minyoung Park, Portland, OR (US)

(72) Inventor: Minyoung Park, Portland, OR (US)

(21) Appl. No.: 13/730,987

(22) Filed: Dec. 29, 2012

(51) Int. Cl. H04W 28/02

(52) U.S. Cl. CPC H04W 28/0231
USPC 370/230

(57) ABSTRACT

Embodiments may implement a hierarchical data structure for traffic indication mapping. Many embodiments facilitate establishing a number of pages and a number of blocks per page in a bitmap structure. For instance, several embodiments may determine a number of pages (Np) and a number of blocks per page (Nb) in the bitmap structure and communicate these to a station to facilitate communication of TIM elements to the station by an access point. In several embodiments, an access point may determine the number of pages and number of blocks per page and may transmit these numbers to stations as the stations associate with the access point such as in association response frames. In further embodiments, the access point may dynamically change the number of pages and/or the number of blocks per page by transmitting a TIM element to the stations in a beacon frame.

### BACKGROUND

Embodiments are in the field of wireless communications. More particularly, the present disclosure relates to communicating a number of pages and a number blocks per page in a hierarchical data structure of a traffic indication map.

### BRIEF DESCRIPTION OF THE DRAWINGS

FIG. 1 depicts an embodiment of a wireless network comprising a plurality of communications devices, including multiple fixed or mobile communications devices;

FIG. 1A depicts an embodiment of a hierarchical data structure for traffic indication mapping with four pages and 32 blocks per page;

FIG. 1B depicts an embodiment of an association identifier structure for the hierarchical data structure illustrated in FIG. 1A;

FIG. 1C depicts an embodiment of a management frame with a traffic indication map element for communications between wireless communication devices;

FIG. 1D depicts an embodiment of a traffic indication map information element for communications between wireless communication devices via a bitmap frame such as the traffic indication map element illustrated in FIG. 1C;

FIG. 1E depicts an embodiment of traffic indication map virtual bitmap control field such as the hierarchical data structure such as the traffic indication map control field illustrated in FIG. 1D;

FIG. 1F depicts an embodiment of a traffic indication map parameter field such as the traffic indication map parameter field illustrated in FIG. 1D;

FIG. 1G depicts an embodiment of a traffic indication map parameter element such as the traffic indication map element illustrated in FIG. 1C for frames such as association frames and beacon frames;

FIG. 2 depicts an embodiment of an apparatus to generate, transmit, receive and interpret a frame with a partial virtual bitmap based upon a hierarchical data structure for traffic indication mapping;

FIG. 3 depicts an embodiment of a flowchart to generate a frame with a partial virtual bitmap based upon a hierarchical data structure for traffic indication mapping;

FIGS. 4A-B depict embodiments of flowcharts to transmit, receive, and interpret communications with frames having virtual bitmaps based upon a hierarchical data structure for traffic indication mapping as illustrated in FIG. 2; and

FIGS. 5A-B depict embodiments of flowcharts to receive and decode frames with traffic indication map parameter information elements and traffic indication map information elements.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

Embodiments may implement a new hierarchical data structure for traffic indication mapping (TIM) to facilitate transmissions for wireless communications devices. Many embodiments facilitate establishing a number of pages and a number of blocks per page in a TIM bitmap structure. For instance, several embodiments may determine a number of pages (Np) and a number of blocks per page (Nb) in the TIM bitmap structure and communicate these between an access point and a station to facilitate communication of TIM bitmap elements to the station by the access point. In several embodiments, an access point may determine the number of pages and number of blocks per page and may transmit these numbers to the stations as the stations associate with the access point such as in association response frames. In further embodiments, the access point may dynamically change the number of pages and/or the number of blocks per page by transmitting a TIM parameter information element (IE) to the stations in a beacon frame.

In some embodiments, the access point may transmit the number of pages (Np) and the number of blocks per page (Nb) with a TIM bitmap, referred to as a partial virtual bitmap, that implements the number of pages and number of blocks per page. Such embodiments may determine a TIM segment index and a Page index for the bitmap control field of the TIM bitmap element based upon the number of pages and the number of blocks per page. For instance, an access point with a partial virtual bitmap with a hierarchical structure having four pages and 32 blocks per page may implement five bits for the TIM segment element of the block control field and may implement two bits for the page index of the block control field. On the other hand, if the number of pages is changed to or set at 16 and the number of blocks per page is changed to or set at 16, the number of bits in the TIM Segment may be shortened to four bits and the number of bits in the page index may be lengthened to three bits. In several embodiments, the number of bits (P) in the TIM Segment index may be set equal to LOG base2 of Nb and the number of bits (Q) in the Page index may be set equal to LOG base2 of Np.

In some embodiments, the number of pages (Np) and the number of blocks in a page (Nb) may be signaled in a separate TIM parameter field in a TIM information element (IE). The TIM parameter field may comprise a number of pages field and a number of blocks field. This may increase the size of the TIM IE by one octet but all the information needed to interpret the received TIM IE can be contained in the TIM IE.

Various embodiments may be designed to address different technical problems associated with communicating an indication of a traffic indication map for a large number of devices. For instance, some embodiments may be designed to address one or more technical problems such as communicating the number of pages in a traffic indication map and the number of blocks per page in the traffic indication map for the first time and to update stations to the current values.

Different technical problems such as those discussed above may be addressed by one or more different embodiments. For instance, some embodiments that communicate the number of pages in a traffic indication map and the number of blocks per page in the traffic indication map for the first time and to update stations to the current values may do so by one or more different technical means such as inclusion of a field value in TIM information element and/or defining a TIM parameter field in a TIM information element indicating the number of pages in a traffic indication map and the number of blocks per page in the traffic indication map.

In several embodiments, an association identifier (AID) structure is defined for the hierarchical data structure for traffic indication mapping. In many embodiments, the AID structure comprises bits identifying a page, bits identifying a block, bits identifying a page or block extension, bits identifying a sub-block, and bits identifying a station within the particular sub-block. A station associated with an AP may parse the AID to determine the page, block, and, depending on the block encoding, the sub-block, and bit position within that sub-block of a TIM information element that identifies whether or not the AP is buffering data for the station.

Some embodiments implement Institute of Electrical and Electronic Engineers (IEEE) 802.11 systems such as IEEE 802.11ah systems and other systems that operate in accordance with standards such as the IEEE 802.11-2012, IEEE Standard for Information technology—Telecommunications and information exchange between systems—Local and metropolitan area networks—Specific requirements—Part 11: Wireless LAN Medium Access Control (MAC) and Physical Layer (PHY) Specifications (http://standards.ieee.org/getieee802/download/802.11-2012.pdf).

According to one embodiment, the partial virtual bitmap based upon the hierarchical data structure for traffic indication mapping is defined to enable a greater number of associated stations and to utilize a more efficient TIM element and, in many instances, smaller TIM element for low-power consumption stations such as small battery-powered wireless devices (e.g., sensors) to use Wi-Fi to connect to the Internet with very low power consumption.

Several embodiments comprise access points (APs) for and/or client devices of APs or stations (STAs) such as routers, switches, servers, workstations, netbooks, mobile devices (Laptop, Smart Phone, Tablet, and the like), as well as sensors, meters, controls, instruments, monitors, appliances, and the like. Some embodiments may provide, e.g., indoor and/or outdoor “smart” grid and sensor services. For example, some embodiments may provide a metering station to collect data from sensors that meter the usage of electricity, water, gas, and/or other utilities for a home or homes within a particular area and wirelessly transmit the usage of these services to a meter substation. Further embodiments may collect data from sensors for home healthcare, clinics, or hospitals for monitoring healthcare related events and vital signs for patients such as fall detection, pill bottle monitoring, weight monitoring, sleep apnea, blood sugar levels, heart rhythms, and the like. Embodiments designed for such services may generally require much lower data rates and much lower (ultra low) power consumption than devices provided in IEEE 802.11n/ac systems.

Logic, modules, devices, and interfaces herein described may perform functions that may be implemented in hardware and/or code. Hardware and/or code may comprise software, firmware, microcode, processors, state machines, chipsets, or combinations thereof designed to accomplish the functionality.

Embodiments may facilitate wireless communications. Some embodiments may comprise low power wireless communications like Bluetooth®, wireless local area networks (WLANs), wireless metropolitan area networks (WMANs), wireless personal area networks (WPAN), cellular networks, communications in networks, messaging systems, and smart-devices to facilitate interaction between such devices. Furthermore, some wireless embodiments may incorporate a single antenna while other embodiments may employ multiple antennas. The one or more antennas may couple with a processor and a radio to transmit and/or receive radio waves. For instance, multiple-input and multiple-output (MIMO) is the use of radio channels carrying signals via multiple antennas at both the transmitter and receiver to improve communication performance.

While some of the specific embodiments described below will reference the embodiments with specific configurations, those of skill in the art will realize that embodiments of the present disclosure may advantageously be implemented with other configurations with similar issues or problems.

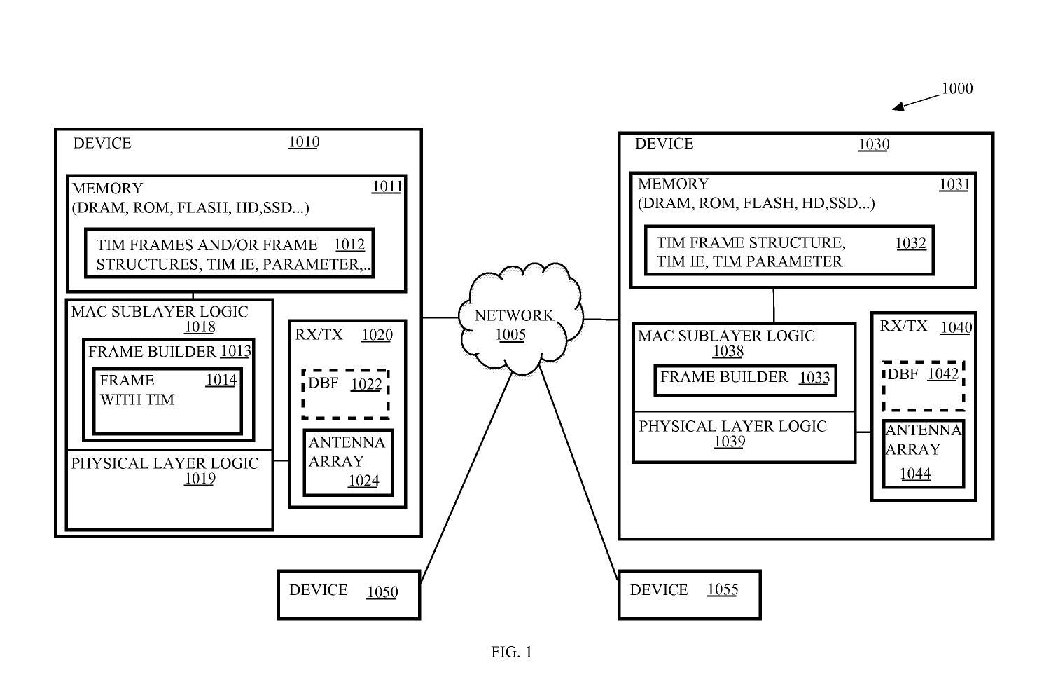

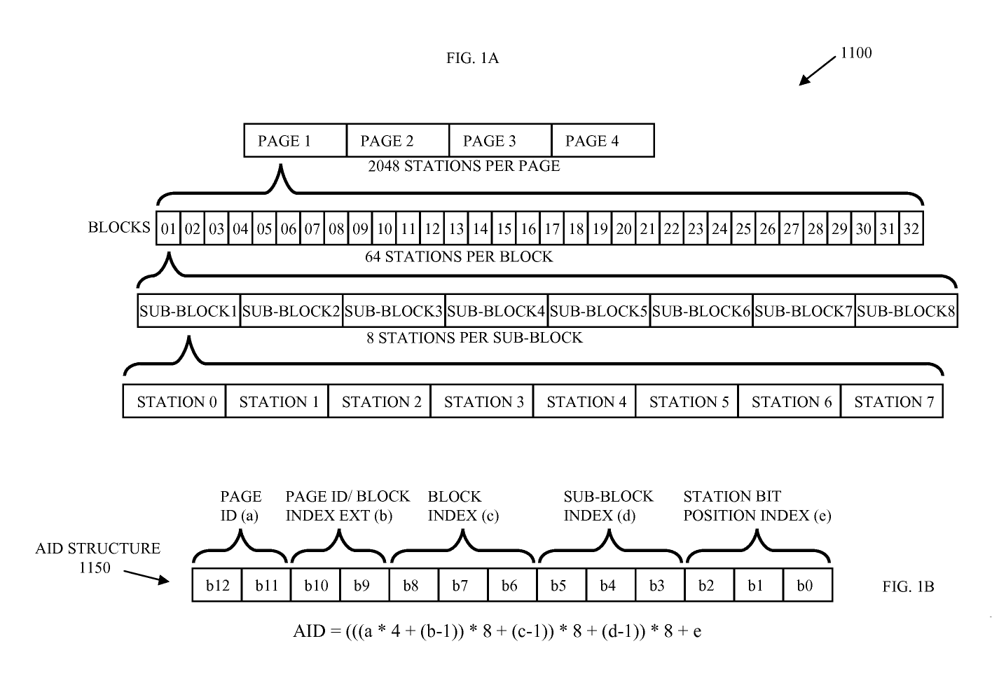

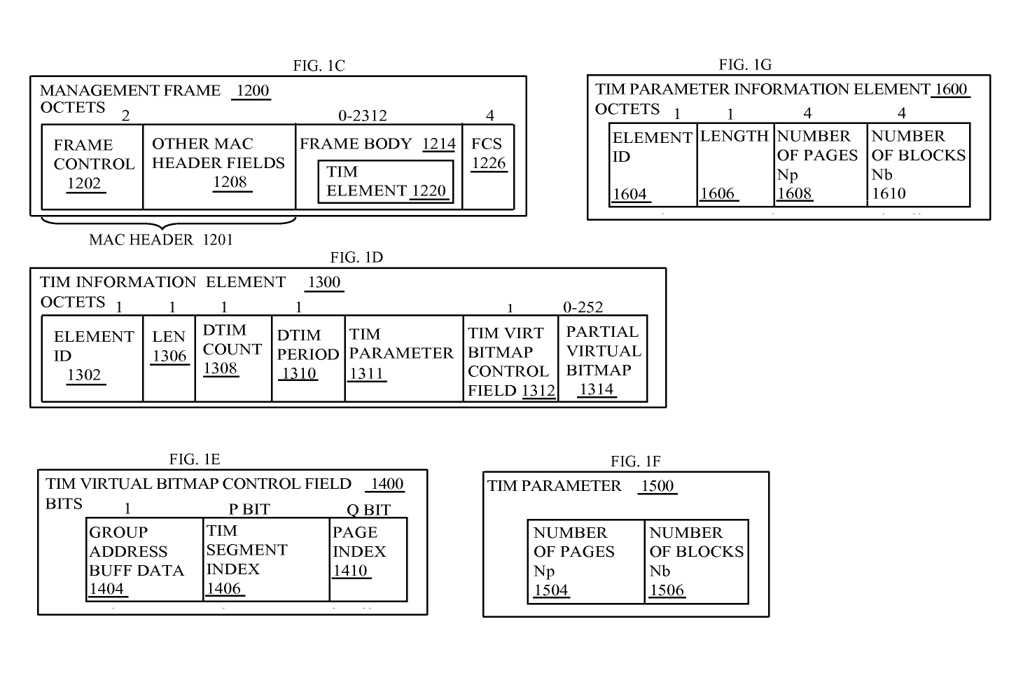

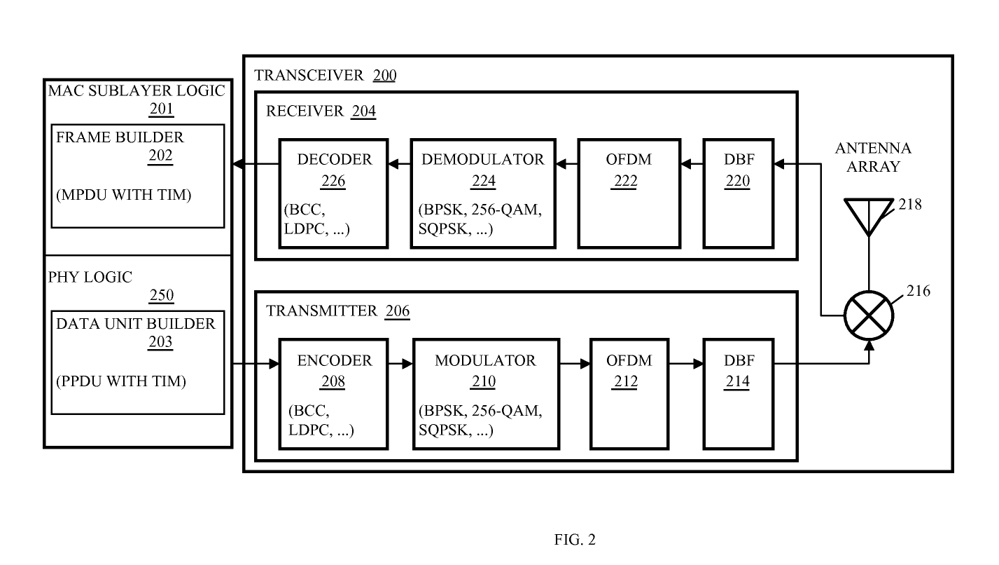

Turning now to FIG. 1, there is shown an embodiment of a wireless communication system 1000. The wireless communication system 1000 comprises a communications device 1010 that may be wire line and wirelessly connected to a network 1005. The communications device 1010 may communicate wirelessly with a plurality of communication devices 1030, 1050, and 1055 via the network 1005. The communications device 1010 may comprise an access point. The communications device 1030 may comprise a low power communications device such as a sensor, a consumer electronics device, a personal mobile device, or the like. And communications devices 1050 and 1055 may comprise sensors, stations, access points, hubs, switches, routers, computers, laptops, netbooks, cellular phones, smart phones, PDAs (Personal Digital Assistants), or other wireless-capable devices. Thus, communications devices may be mobile or fixed. For example, the communications device 1010 may comprise a metering substation for water consumption within a neighborhood of homes. Each of the homes within the neighborhood may comprise a sensor such as the communications device 1030 and the communications device 1030 may be integrated with or coupled to a water usage meter.

Initially, the communications device 1030 may associate with the communications device 1010 and receive an association identifier (AID) from the communications device 1010 to uniquely identify the communications device 1030 with respect to other communications devices associated with the communications device 1010. In many embodiments, the AID may comprise 13 bits, wherein the bits identify the page, block, sub-block, and a bit position for the station within the sub-block. FIG. 1B depicts an embodiment of such an AID structure 1150. Furthermore, the communications device 1010 may include in the association response frame, a TIM parameter information element including a number of pages (Np) and a number of blocks in a page (Nb). The communications device 1030 may parse the association response to determine the Np and Nb. In several embodiments, the communications device 1030 may monitor beacons from the communications device 1010 to determine if the values of Np and Nb change or are updated by the communications device 1010. Thereafter, the communications device 1010 may buffer data such as medium access control (MAC) service data units (MSDUs) for the communications device 1030.

After buffering an MSDU for the communications device 1030, the communications device 1010 may transmit a beacon to associated devices, identifying the devices with data buffered by the communications device 1010 by means of a traffic indication map (TIM) element such as the frame 1014. The beacon may include a separate information element that changes in the values of Np and Nb such as a TIM parameter information element or the beacon may comprise values of the Np and the Nb in a TIM parameter field of the TIM information element. The receiving station may utilize the values of Np and Nb in the TIM parameter information element or the TIM parameter field of the TIM information element to interpret the bitmap control field and the block offset field of the encoded TIM bitmap field or partial virtual bitmap field.

In the present embodiment, the TIM element may identify the AID of each station that has data buffered such as the communications device 1030 by identifying the page, the block, and, depending upon the encoding of the block, the sub-block of the stations. The TIM element may also comprise a number of bits such as eight bits that identify the stations in the sub-block that have buffered data via logical ones and zeroes. In many embodiments, a logical one at the bit location in the sub-block associated with the communications device 1030 may indicate that the communications device 1010 is buffering data for the communications device 1030. In further embodiments, a logical zero may represent that the communications device 1010 is buffering data for the communications device 1030.

The communications device 1030 may interpret the TIM element based upon the association identifier (AID) assigned to the communications device 1030 by the communications device 1010. In many embodiments, the communications device 1030 may parse the AID to determine a page associated with communications device 1030 and may parse the TIM element to determine if the TIM element describes data buffering for stations associated with the same page. If so, the communications device 1030 may parse the TIM element to determine if the TIM element describes data buffering for stations if the block index from the AID falls within the range of block indexes identified by a start block index and/or an end block index. If so, the communications device 1030 may repeat the process of parsing the AID and comparing the values of the block and sub-block with those represented by the TIM element to determine whether the TIM element indicates that the communications device 1010 is buffering data for the communications device 1030 and/or whether the TIM element includes data at the bit position in the sub-block associated with the communications device 1030 that indicates that the communications device 1010 is buffering data for the communications device 1030. In other embodiments, the TIM information element may comprise a TIM segment number and each station such as communications devices 1030, 1050, and 1055 may receive a TIM segment number to indicate which TIM segment comprises information for the station about data buffered by the communications device 1010 for the station.

In further embodiments, the communications device 1010 may facilitate data offloading. For example, communications devices that are low power sensors may include a data offloading scheme to, e.g., communicate via Wi-Fi, another communications device, a cellular network, or the like for the purposes of reducing power consumption consumed in waiting for access to, e.g., a metering station and/or increasing availability of bandwidth. Communications devices that receive data from sensors such as metering stations may include a data offloading scheme to, e.g., communicate via Wi-Fi, another communications device, a cellular network, or the like for the purposes of reducing congestion of the network 1005.

The network 1005 may represent an interconnection of a number of networks. For instance, the network 1005 may couple with a wide area network such as the Internet or an intranet and may interconnect local devices wired or wirelessly interconnected via one or more hubs, routers, or switches. In the present embodiment, network 1005 communicatively couples communications devices 1010, 1030, 1050, and 1055.

The communication devices 1010 and 1030 comprise memory 1011 and 1031, medium access control (MAC) sublayer logic 1018 and 1038, and physical layer (PHY) logic 1019 and 1039, respectively. The memory 1011 and 1031 may comprise a storage medium such as dynamic random access memory (DRAM), read only memory (ROM), buffers, registers, cache, flash memory, hard disk drives, solid-state drives, or the like. The memory 1011 and 1031 may store frames and/or frame structures, or portions thereof such as a management frame structure and a traffic indication map (TIM) element based upon a hierarchical data structure such as the hierarchical data structure 1100 illustrated in FIG. 1A. Furthermore, the memory 1011 and 1031 may comprise a traffic indication map in a hierarchical data structure that identifies the associated stations for which data is buffered. For example, the memory 1011 may comprise an indication that the communications device 1010 comprises buffered data as well as a reference or link to the buffered data for the communications device 1030.

The MAC sublayer logic 1018, 1038 may comprise logic to implement functionality of the MAC sublayer of the data link layer of the communications device 1010, 1030. The MAC sublayer logic 1018, 1038 may generate the frames such as management frames and the physical layer logic 1019, 1039 may generate physical layer protocol data units (PPDUs) based upon the frames. For example, the frame builder 1013 may generate frames with a TIM element 1014 and the data unit builder of the physical layer logic 1019 may encapsulate the frames with preambles to generate PPDUs for transmission via a physical layer device such as the transceivers (RX/TX) 1020 and 1040.

The frame with the TIM element 1014 may comprise a frame such as the management frame 1200 in FIG. 1C. In particular, the frame with the TIM element 1014 may comprise a TIM information element with a bitmap or a partial virtual bitmap based upon a hierarchical data structure and may identify each station within, e.g., one page, that has data buffered by an AP such as communications device 1010. For example, the AP may not arbitrarily transmit MSDUs to stations operating in a power saving (PS) mode, but may buffer the MSDUs and only transmit the MSDUs at designated times. Furthermore, the stations that currently have buffered MSDUs within the AP may be identified in frame comprising a TIM information element, which may be included, e.g., as an element within beacon frames generated by the AP. Then, each station may determine that an MSDU is buffered for the station (such as communications device 1030) by receiving and interpreting the TIM information element in the beacon frame. The station may interpret the TIM information element by determining whether the page including their AID is included in the TIM information element, determining whether the block index of their AIDs is included within the range of block indexes described in the element, determining whether the block with their AID is included in the TIM information element, and, if, so, determining whether the TIM information element indicates that the value associated with their AID indicates that data is being buffered at the AP. In a base service set (BSS) operating under a distributed coordination function (DCF), upon determining that an MSDU is currently buffered in the AP, a station operating in the PS mode may transmit a PS-Poll frame to the AP. The AP may respond with the corresponding buffered MSDU immediately, or acknowledge the PS-Poll and respond with the corresponding MSDU at a later time.

The communications devices 1010, 1030, 1050, and 1055 may each comprise a transceiver such as transceivers 1020 and 1040. Each transceiver 1020, 1040 comprises an RF transmitter and an RF receiver. Each RF transmitter impresses digital data onto an RF frequency for transmission of the data by electromagnetic radiation. An RF receiver receives electromagnetic energy at an RF frequency and extracts the digital data therefrom.

FIG. 1 may depict a number of different embodiments including a Multiple-Input, Multiple-Output (MIMO) system with, e.g., four spatial streams, and may depict degenerate systems in which one or more of the communications devices 1010, 1030, 1050, and 1055 comprise a receiver and/or a transmitter with a single antenna including a Single-Input, Single Output (SISO) system, a Single-Input, Multiple Output (SIMO) system, and a Multiple-Input, Single Output (MISO) system.

In many embodiments, transceivers 1020 and 1040 implement orthogonal frequency-division multiplexing (OFDM). OFDM is a method of encoding digital data on multiple carrier frequencies. OFDM is a frequency-division multiplexing scheme used as a digital multi-carrier modulation method. A large number of closely spaced orthogonal sub-carrier signals are used to carry data. The data is divided into several parallel data streams or channels, one for each sub-carrier. Each sub-carrier is modulated with a modulation scheme at a low symbol rate, maintaining total data rates similar to conventional single-carrier modulation schemes in the same bandwidth.

In some embodiments, the communications device 1010 optionally comprises a Digital Beam Former (DBF) 1022, as indicated by the dashed lines. The DBF 1022 transforms information signals into signals to be applied to elements of an antenna array 1024. The antenna array 1024 is an array of individual, separately excitable antenna elements. The signals applied to the elements of the antenna array 1024 cause the antenna array 1024 to radiate one to four spatial channels. Each spatial channel so formed may carry information to one or more of the communications devices 1030, 1050, and 1055. Similarly, the communications device 1030 comprises a transceiver 1040 to receive and transmit signals from and to the communications device 1010. The transceiver 1040 may comprise an antenna array 1044 and, optionally, a DBF 1042.

FIG. 1A depicts an embodiment of a hierarchical data structure 1100 for traffic indication mapping with four pages (Np) and 32 blocks per page (Nb). On the top level of the hierarchy, the traffic indication virtual map may be divided into four pages (Np). Each page may support up to 2048 stations and, in several embodiments, each page may be transmitted as a partial virtual bitmap in a separate TIM information element. In some embodiments, multiple TIM information elements may be transmitted in the same medium access control (MAC) service data unit (MSDU). In further embodiments, multiple MSDUs may be aggregated in each physical layer (PHY) protocol data units (PPDUs). In other embodiments, the hierarchical data structure 1100 may comprise more or less than four pages (Np).

Each page illustrated comprises up to 32 blocks per page (Nb) and each of the 32 blocks may support up to 64 of the stations. Each block may comprise eight sub-blocks. Each sub-block may be one octet in length and may support eight of the stations associated with the corresponding block. In further embodiments, each block may comprise more or less than eight sub-blocks and each of the sub-blocks may be more or less than one octet in length.

Each bit of a sub-block may correspond to a different association identifier (AID) and thus, each bit may uniquely identify a station. In the present embodiment, the bit may be set to 1 if there is data buffered at the AP. Otherwise, the bit may be cleared to 0.

In several embodiments, the Np and Nb values are established at the time of association of a station with an access point. In some embodiments, the values of Np and Nb may be updated or changed in TIM parameter information elements of, e.g., beacons transmitted by the access point. In other embodiments, the values of Np and Nb may be transmitted in the TIM information element with the bitmap or partial virtual bitmap.

FIG. 1B depicts an embodiment of an association identifier structure 1150 for the hierarchical data structure illustrated in FIG. 1A. In the present embodiment, the AID comprises 13 bits. In other embodiments, the AID structure 1150 may comprise more or less than 13 bits.

In the present embodiment, the AID structure 1150 may comprise a page identifier (ID) having two bits (b12-b11), which is represented as “a” in the AID equation depicted below the AID structure 1150. The AID structure 1150 may comprise a page ID/block index extension having two bits (b10-b9), which is represented as “b” in the AID equation. The page ID/block index extension may facilitate a greater ratio of pages per block or blocks per page. The AID structure 1150 may comprise a block index having three bits (b8-b6), which is represented as “c” in the AID equation. The AID structure 1150 may comprise a sub-block index having three bits (b5-b3), which is represented as “d” in the AID equation. And, the AID structure 1150 may comprise a station bit position index having three bits (b2-b0), which is represented as “e” in the AID equation.

The AID equation may describe the calculation of a unique number per station based upon the hierarchical data structure illustrated in FIG. 1A. In particular, the AID unique number in this embodiment may be calculated by the following formula:

AID=((((Page ID×4+(Page ID/Block index extension−1))×8+(Block index−1))×8+(Sub-block index−1))×8+(station bit position index)

To illustrate, if the variables are: the Page ID=0, the page ID/block index=1, the block index=2, the sub-block index=6. As a result, the equation becomes:

AID=((((0×4+(1−1))×8+(2−1))×8+(6−1))×8+(4)=108

FIG. 1C depicts an embodiment of a management frame 1200 for communications between wireless communication devices such as communications devices 1010, 1030, 1050, and 1055 in FIG. 1. The management frame 1200 may comprise a MAC header 1201, a frame body 1214, and a frame check sequence (FCS) field 1226. The MAC header 1201 may comprise the frame control field 1202 and other MAC header fields 1208. The frame control field 1202 may be two octets and may identify the type and subtype of the frame such as a management type and, e.g., a beacon frame subtype or an association response frame subtype. The other MAC header fields 1208 may comprise, for example, one or more address fields, identification fields, control fields, or the like.

In some embodiments, the management frame 1200 may comprise a frame body 1214. The frame body 1214 may be a variable number of octets and may include data elements, control elements, or parameters and capabilities. In the present embodiment, the frame body 1214 comprises a traffic indication map (TIM) element 1220 such as a TIM information element 1300 as illustrated in FIG. 1D or a TIM parameter information element 1600 as illustrated in FIG. 1G.

FIG. 1D illustrates an embodiment of a TIM information element 1300. An access point (AP) may transmit the TIM information element 1300 to inform stations such as low power sensors that the AP is buffering data for the station. In many embodiments, the station may then initiate communications with the AP to obtain the buffered data such as via a poll frame. In other embodiments, the AP may transmit the data to the station after transmitting the beacon.

The TIM information element 1300 may comprise fields such as an element identifier (ID) field 1302, a length field 1306, a delivery TIM (DTIM) count field 1308, a DTIM period field 1310, a TIM parameter field 1311, a TIM virtual bitmap control field 1312, and partial virtual bitmap 1314. The element ID field 1302 may be one octet and may identify the element as a TIM element 1300. The length field 1306 may be one octet and may define the length of the TIM element 1300 or the length of a portion thereof. The DTIM count 1308 may be one octet and may indicate how many beacon frames (including the current frame) appear before the next DTIM frame. A DTIM Count field 1308 value of 0 may indicate that the current TIM information element frame is a DTIM frame. For instance, immediately after every DTIM (beacon frame with DTIM Count field 1308 of the TIM information element 1300 equal to zero), the AP shall transmit all buffered, group-addressed frames. If the TIM indicating the buffered MSDU or aggregate MSDU (A-MSDU) is sent during a contention-free period (CFP), a contention-free (CF)-Pollable station operating in the power-savings (PS) mode does not send a power-saving (PS)-Poll frame, but remains active until the buffered MSDU or A-MSDU is received (or the CFP ends). If any station in its base service set (BSS) is in PS mode, the AP may buffer all group-addressed MSDUs and deliver them to all stations immediately following the next beacon frame containing a DTIM transmission.

The DTIM period field 1310 may be one octet and may indicate the number of beacon intervals between successive DTIMs. In many embodiments, if all TIM information element frames are DTIMs, the DTIM period field 1310 may have the value 1.

The TIM parameter field 1311 may comprise the values of Np and Nb. For instance, FIG. 1F illustrates an embodiment of the TIM parameter field 1500, which comprises a number of pages (Np) field 1504 and a number of blocks per page (Nb) field 1506.

The TIM virtual bitmap control field 1312 may be one or two octets and may describe the content of the partial virtual bitmap 1314. For instance, the TIM virtual bitmap may include a bit such as bit 0 that contains a traffic indicator bit associated with Group Address Buffered Data 0. This bit may be set to 1 in TIM information elements 1300 with a value of 0 in the DTIM Count field 1308 when one or more group-addressed frames are buffered at the AP.

An embodiment of a TIM virtual partial bitmap control field 1400 may comprise an group address buffered data field 1404, a TIM Segment Index field 1406, and a page index field 1410. The TIM Segment Index field 1406 may be p bits and the page index field 1410 may be q bits. The values of p bits and q bits vary based upon the number of pages in the traffic indication map and the number of blocks per page in the traffic indication map. In many embodiments, p bits may be determined as the p=log base2 of Nb and q bits may be determined as the q=log base2 of Np.

The TIM Segment Index field 1406 and the page index field 1410 may indicate blocks of pages included in the TIM information element. For instance, the virtual partial bitmap may comprise one of one or more segments of the entire bitmap of stations. The TIM Segment Index field 1406 may describe the starting block and the range of blocks included in the partial virtual bitmap segment included in the TIM information element. The page index field 1410 may indicate a page index of the partial virtual bitmap. For instance, a page index may be 2 bits in length and may indicate the page index of 0 through 3 (binary bits 00, 01, 10, and 11, respectively) to represent four pages. In some embodiments, the number of pages may be extended via the page ID/block index extension field to describe, e.g., eight or 16 pages rather than four pages.

Referring again to FIG. 1D, the partial virtual bitmap field 1314 may be a segment of the bitmap for stations associated with the access point and may comprise bits describing stations for which data is buffered by the AP based upon a hierarchical data structure such as the hierarchical data structure illustrated in FIG. 1A.

Referring again to FIG. 1G, the TIM parameter information element 1600 may be a TIM element 1220 as illustrated in FIG. 1C in, e.g., a beacon frame or an association frame such as an association response frame. The TIM parameter information element 1600 may describe the values of Np and Nb in an information element having an element identifier of Element ID 1604. The TIM parameter information element 1600 may be a length 1606 and the values of Np and Nb may be number of pages Np 1608 and number of blocks Nb 1610, respectively.

Referring again to FIG. 1C, in many embodiments, the management frame 1200 may comprise a frame check sequence (FCS) field 1226. The FCS field 1226 may be four octets and may include extra checksum characters added to the short frame 1060 for error detection and correction.

FIG. 2 depicts an embodiment of an apparatus to generate, transmit, receive, and interpret or decode a traffic indication map (TIM) element in a frame. The apparatus comprises a transceiver 200 coupled with Medium Access Control (MAC) sublayer logic 201 and a physical layer (PHY) logic 250. The MAC sublayer logic 201 may determine a frame and the physical layer (PHY) logic 250 may determine the PPDU by encapsulating the frame or multiple frames, MAC protocol data units (MPDUs), with a preamble to transmit via transceiver 200.

In many embodiments, the MAC sublayer logic 201 may comprise a frame builder 202 to generate frames such as one of the management frame 1200 with TIM element 1220 illustrated in FIGS. 1C-F. The TIM elements may comprise data indicative of MAC service data units (MSDUs) buffered or stored by an associated access point (AP) for particular stations associated with the AP. Association identifiers (AIDs) may identify the stations. The AP such as the communications device 1010 and a station such as the communications device 1030 in FIG. 1 may maintain some or part of the TIM elements 1220 or 1300 and values in memory such as the memory 1012 and 1032 illustrated in FIG. 1.

The PHY logic 250 may comprise a data unit builder 203. The data unit builder 203 may determine a preamble to encapsulate the MPDU or more than one MPDUs to generate a PPDU. In many embodiments, the data unit builder 203 may create the preamble based upon communications parameters chosen through interaction with a destination communications device.

The transceiver 200 comprises a receiver 204 and a transmitter 206. The transmitter 206 may comprise one or more of an encoder 208, a modulator 210, an OFDM 212, and a DBF 214. The encoder 208 of transmitter 206 receives and encodes data destined for transmission from the MAC sublayer logic 202 with, e.g., a binary convolutional coding (BCC), a low density parity check coding (LDPC), and/or the like. The modulator 210 may receive data from encoder 208 and may impress the received data blocks onto a sinusoid of a selected frequency via, e.g., mapping the data blocks into a corresponding set of discrete amplitudes of the sinusoid, or a set of discrete phases of the sinusoid, or a set of discrete frequency shifts relative to the frequency of the sinusoid. The output of modulator 210 is fed to an orthogonal frequency division multiplexer (OFDM) 212, which impresses the modulated data from modulator 210 onto a plurality of orthogonal sub-carriers. And, the output of the OFDM 212 may be fed to the digital beam former (DBF) 214 to form a plurality of spatial channels and steer each spatial channel independently to maximize the signal power transmitted to and received from each of a plurality of user terminals.

The transceiver 200 may also comprise duplexers 216 connected to antenna array 218. Thus, in this embodiment, a single antenna array is used for both transmission and reception. When transmitting, the signal passes through duplexers 216 and drives the antenna with the up-converted information-bearing signal. During transmission, the duplexers 216 prevent the signals to be transmitted from entering receiver 204. When receiving, information bearing signals received by the antenna array pass through duplexers 216 to deliver the signal from the antenna array to receiver 204. The duplexers 216 then prevent the received signals from entering transmitter 206. Thus, duplexers 216 operate as switches to alternately connect the antenna array elements to the receiver 204 and the transmitter 206.

The antenna array 218 radiates the information bearing signals into a time-varying, spatial distribution of electromagnetic energy that can be received by an antenna of a receiver. The receiver can then extract the information of the received signal.

The transceiver 200 may comprise a receiver 204 for receiving, demodulating, and decoding information bearing signals. The receiver 204 may comprise one or more of a DBF 220, an OFDM 222, a demodulator 224 and a decoder 226. The received signals are fed from antenna elements 218 to a Digital Beam Former (DBF) 220. The DBF 220 transforms N antenna signals into L information signals. The output of the DBF 220 is fed to the OFDM 222. The OFDM 222 extracts signal information from the plurality of subcarriers onto which information-bearing signals are modulated. The demodulator 224 demodulates the received signal, extracting information content from the received signal to produce an un-demodulated information signal. And, the decoder 226 decodes the received data from the demodulator 224 and transmits the decoded information, the MPDU or more than one MPDUs, to the MAC sublayer logic 201.

Persons of skill in the art will recognize that a transceiver may comprise numerous additional functions not shown in FIG. 2 and that the receiver 204 and transmitter 206 can be distinct devices rather than being packaged as one transceiver. For instance, embodiments of a transceiver may comprise a Dynamic Random Access Memory (DRAM), a reference oscillator, filtering circuitry, synchronization circuitry, an interleaver and a deinterleaver, possibly multiple frequency conversion stages and multiple amplification stages, etc. Further, some of the functions shown in FIG. 2 may be integrated. For example, digital beam forming may be integrated with orthogonal frequency division multiplexing.

The MAC sublayer logic 201 may decode or parse the MPDU or MPDUs to determine the particular type of frame or frames and identify one or more TIM elements included in the MPDU(s). For each TIM information element, the MAC sublayer logic 201 may parse the TIM information element to determine the number of pages and the number of blocks per page so the MAC sublayer logic 201 can parse the bitmap control field and block offset field of the TIM bitmap. If a bit associated with the receiving station is not present or is a logical zero, then the receiving station may not have data buffered at the AP. On the other hand, if the bit associated with the receiving station is present and is a logical one, the receiving station may have data buffered at the AP.

In other embodiments, if an inverse encoding for a block is set in the TIM element, the sub-blocks may refer to sub-blocks that do not have data buffered, or the bits associated with the AID of the receiving station may comprise a logical zero to indicate that data is buffered for the receiving station at the AP and a logical one to indicate that data is not buffered at the AP.

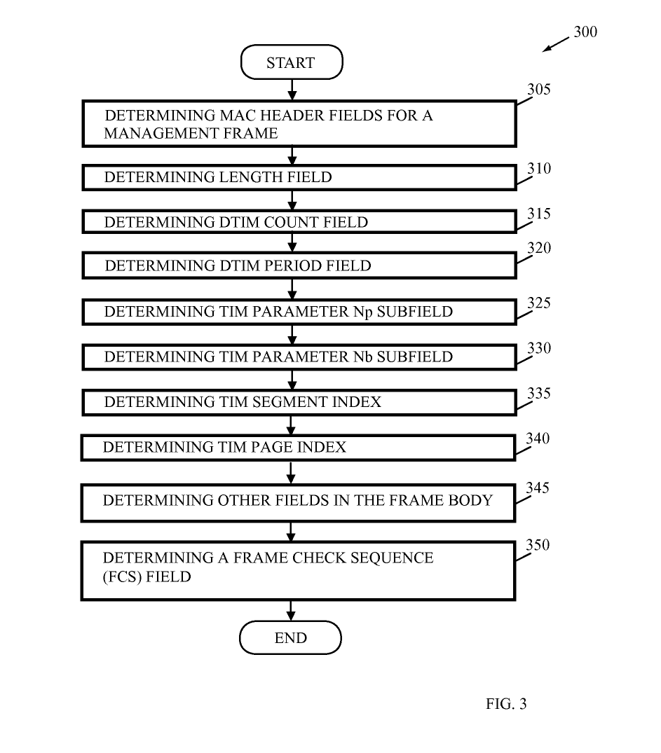

FIG. 3 depicts an embodiment of a flowchart to generate a frame with a partial virtual bitmap based upon a hierarchical data structure for traffic indication mapping described in conjunction with FIGS. 1-2. The flowchart 300 may begin with determining MAC header fields for a management frame (element 305). For instance, MAC logic such as the MAC sublayer logic 1018 of the communications device 1010 in FIG. 1 may determine a value for a frame control field including the type and subtype values indicative of the particular type of management frame as well as other MAC header fields.

After determining the MAC header, the MAC logic may determine the length to include in the length field (element 310). The length may be the length of the entire frame, the length of the partial virtual bitmap, or another length. The MAC logic may determine the DTIM count field value (element 315), the DTIM period value (element 320), and then the TIM parameter field value including the values of the subfields for the number of pages (Np) (element 325) and the number of blocks per page (Nb) (element 330). In many embodiments, the MAC logic may access memory such as memory 1011 in FIG. 1 to determine that current page and block counts of the traffic indication map. For example, some embodiments allow for the access point (AP) to adjust the structure of the traffic indication map based upon usage. If, for instance, the AP defaults to a structure in which the traffic indication map comprises four pages and 32 blocks per page, but the AP determines that the devices that the AP communicates with in the APs current deployment would be better served by increasing the number of pages and/or decreasing the number of blocks per page, the AP may adjust the values for Np and Nb. The AP may then send an update the values of Np and Nb to stations associated with the AP.

After determining the values for Np and Nb, the MAC logic may determine the TIM segment index (element 335) and the TIM page index (element 340). The number of bits used for the values of the TIM segment index and the page index may vary depending upon the number of pages in the traffic indication map and the number of blocks per page in the traffic indication map. For instance, the number of bits in the TIM segment index may be based on a logarithm of the number of blocks and the number of bits in the page index may be based on a logarithm of the number of pages in the traffic indication map.

Thereafter, the MAC logic may determine other fields in the frame body (element 345) such as a partial virtual bitmap. For instance, the partial virtual bitmap may comprise a block offset field. The block offset field may comprise a value indicative of a block offset for the corresponding block bitmap in the partial virtual bitmap and the block offset may be the number of blocks from the first block in the page represented by the partial virtual bitmap or the first or starting block in the TIM segment represented by the partial virtual bitmap. In such embodiments, the MAC logic may determine the block offset of the first block represented by a bitmap in the partial virtual bitmap based upon the number of pages (Np) and the number of blocks per page (Nb). Alternatively, the MAC logic may read the block offset from memory or from the traffic indication map in the memory.

After determining the rest of the frame, the MAC logic may determine a frame check sequence (FCS) field value (element 350). In some embodiments, for instance, the MAC logic may determine a hash of the frame and include the value of the hash in the FCS field so that a station that receives the frame can perform the same hash to determine if the frame received comprises bit errors.

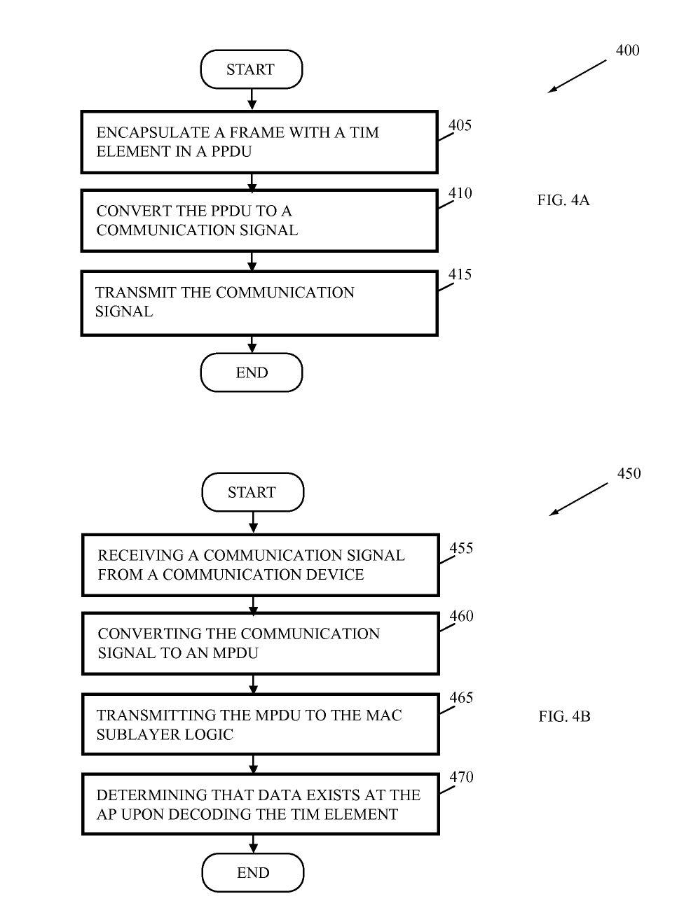

FIGS. 4A-B depict embodiments of flowcharts 400 and 450 to transmit, receive, and interpret or decode communications with a management frame with a TIM element such as the TIM elements illustrated in FIGS. 1C-G. Referring to FIG. 4A, the flowchart 400 may begin with receiving a frame from the frame builder comprising one or more TIM elements such as a TIM information element and/or a TIM parameter information element. The MAC sublayer logic of the communications device may generate the frame as a management frame to transmit to a station and may pass the frame as an MPDU to a data unit builder that transforms the data into a packet that can be transmitted to a station. The data unit builder may generate a preamble to encapsulate one or more of the MPDUs from the frame builder to form a PPDU for transmission (element 405).

The PPDU may then be transmitted to the physical layer device such as the transmitter 206 in FIG. 2 or the transceiver 1020,1040 in FIG. 1 so the PPDU may be converted to a communication signal (element 410). The transmitter may then transmit the communication signal via the antenna (element 415).

Referring to FIG. 4B, the flowchart 450 begins with a receiver of a station such as the receiver 204 in FIG. 2 receiving a communication signal via one or more antenna(s) such as an antenna element of antenna array 218 (element 455). The receiver may convert the communication signal into one or more MPDUs in accordance with the process described in the preamble (element 460). More specifically, the received signal is fed from the one or more antennas to a DBF such as the DBF 220. The DBF transforms the antenna signals into information signals. The output of the DBF is fed to OFDM such as the OFDM 222. The OFDM extracts signal information from the plurality of subcarriers onto which information-bearing signals are modulated. Then, the demodulator such as the demodulator 224 demodulates the signal information via, e.g., BPSK, 16-QAM, 64-QAM, 256-QAM, QPSK, or SQPSK. And the decoder such as the decoder 226 decodes the signal information from the demodulator via, e.g., BCC or LDPC, to extract the one or more MPDUs (element 460) and transmits the one or more MPDUs to MAC sublayer logic such as MAC sublayer logic 202 (element 465).

The MAC sublayer logic may decode the TIM element in each of the MPDUs. For instance, the MAC sublayer logic may parse the TIM element to determine the value of the TIM segment number field, the page ID field, one or more block offset fields, a block control field for one or more blocks, possibly a block bitmap field, and possibly the sub-block bitmap fields for one or more sub-block bitmaps to determine whether the bit associated with the AID for the receiving station indicates that the AP is buffering data for the station (element 470). In some embodiments, the MAC sublayer logic may determine whether the other fields in the TIM element(s) indicate that the data will be broadcast to a group of devices after receipt of the beacon comprising the TIM element, or if the AP will await a frame from the station instructing the AP to send the frame.

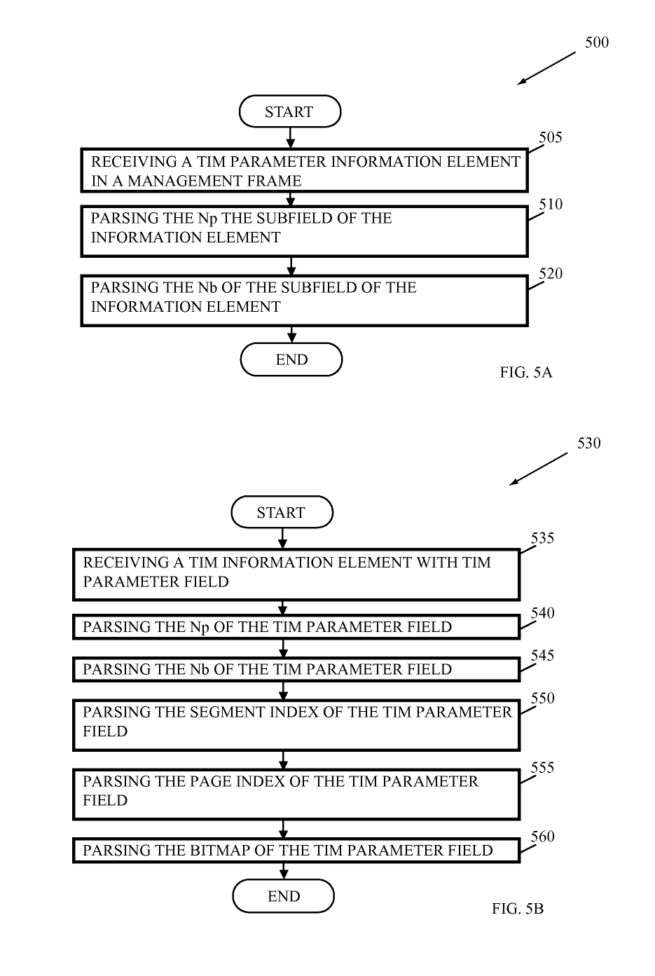

FIGS. 5A-B depict embodiments of flowcharts to receive and decode frames with traffic indication map parameter information elements and traffic indication map information elements. In FIG. 5A, the flowchart 500 begins with receiving a TIM parameter information element in a management frame such as a beacon frame, an association response frame, or other frame (element 505).

After receiving the TIM parameter information element, the PHY logic may decode the fields of the management frame such as the MAC header and then decode the frame body. In several embodiments, after the PHY logic decodes the frame body and passes the decoded frame to the MAC logic, the MAC logic may perform a cyclic redundancy check and parse the frame body to identify the TIM parameter information element. In many embodiments, the MAC logic may access memory such as the memory 1031 in the communications device 1030 of FIG. 1 to determine the frame structure of the TIM parameter information element. After determining the frame structure, the MAC logic may parse the TIM parameter information element to determine the number of pages (Np) in the traffic indication map (element 510). Then the MAC logic may parse the TIM parameter information element to determine the number of blocks per page (Nb) in the traffic indication map (element 520).

In many embodiments, after parsing the TIM parameter element to determine the Np and Nb, the MAC logic may store these values in memory such as memory 1031 for later use to interpret the bitmap control parameter of a TIM information element.

In FIG. 5B, the flowchart 530 begins with receiving a TIM information element with a TIM parameter field in a management frame such as a beacon frame, an association response frame, or other frame (element 535). In many embodiments, the MAC logic may receive a beacon frame with a TIM information element that comprises updates to the number of pages and number of blocks per page values due to an update made by the access point. Such embodiments may further comprise decoding an updated number of pages and an updated number of blocks per page in the beacon frame and storing the updated values for the number of pages and the number of blocks per page in memory such as memory 1031 in FIG. 1.

In many embodiments, the MAC logic may access memory to determine the frame structure of the information element and then may being to parse the information element field by field staring with the first field. Information elements may begin with an element ID and the length so the MAC logic parses the element ID and the length to determine the remaining structure of the information element.

After parsing the element ID and the length of the TIM information element, the MAC logic may parse the DTIM count field, the DTIM period field, and then the TIM parameter field. From the TIM parameter field, the MAC logic may parse two sub-fields, the number of pages (Np) (element 540) and the number of blocks per page (Nb) (element 545).

After parsing the TIM parameter field, the MAC logic may begin parsing the bitmap control field. The MAC logic may use the values determined for Np and Nb from the TIM parameter field to parse the bitmap control field because the number of bits in the TIM segment index sub-field and the page index sub-field of the bitmap control field are related to the values for Np and Nb. In particular, the number of bits in the TIM segment index subfield may be the logarithm base 2 of Nb and the number of bits in the page index sub-field may be logarithm base 2 of Np.

The MAC logic may determine the number of bits in the TIM segment index subfield (p bits) and the number of bits in the page index sub-field (q bits), and use these values to parse the values of the TIM segment index and the page index from the bitmap control field. Furthermore, the MAC logic may use the values of Np and Nb to parse or interpret the block offset field in the partial virtual bitmap such as the block offset field of the partial virtual bitmap 1314 in FIG. 1D.

The following examples pertain to further embodiments. One example comprises a method. The method may involve generating, by a medium access control logic, a frame comprising a traffic indication map element, wherein the traffic indication map element comprises a value for a number of pages indicative of the number of pages in a hierarchical structure for a traffic indication map bitmap and a value for a number of blocks associated with each of the number of pages indicative of the number of blocks associated with each page in the hierarchical structure for the traffic indication map bitmap; and encapsulating, by physical layer logic, the frame with a preamble to create a physical layer protocol data unit to transmit.

In some embodiments, the method may further comprise storing, by the medium access control sublayer logic, a traffic indication map in a memory in accordance with a hierarchical data structure, the hierarchical data structure assigns stations to sub-blocks, assigns sub-blocks to one or more blocks, and assigns the one or more blocks to one or more pages. In some embodiments, the method may further comprise determining an updated number of pages and an updated number of blocks per page and generating a frame including the updated number of pages and the updated number of blocks per page. In many embodiments, generating the frame comprises generating the traffic indication map element comprising a traffic indication map parameter element and the frame comprises an association response frame. In several embodiments, generating the frame comprises generating the traffic indication map element comprising a traffic indication map information element and the frame comprises a beacon frame. And, in some embodiments, generating the frame comprises generating the traffic indication map element comprising a traffic indication map information element and the frame comprising a bitmap control field, wherein the bitmap control field comprises a segment index field and a page index field, the segment index and the page index fields having lengths that vary in relation to the number of pages and the number of blocks.

Another example comprises an apparatus. The apparatus may comprise a memory; a medium access control logic coupled with the memory to generate a frame comprising a traffic indication map element, wherein the traffic indication map element comprises a value for a number of pages indicative of a hierarchical structure for a traffic indication map bitmap and a value for a number of blocks associated with each of the number of pages indicative of the hierarchical structure for the traffic indication map bitmap.

In some embodiments, the apparatus may further comprise a transmitter coupled with the medium access control logic and an antenna to transmit the frame. In some embodiments, the medium access control logic comprises logic to determine an updated number of pages and an updated number of blocks per page and logic to generate a frame including the updated number of pages and the updated number of blocks per page. In some embodiments, the medium access control logic is coupled with the memory to store a traffic indication map in a memory in accordance with a hierarchical data structure, wherein the hierarchical data structure assigns up to eight stations per sub-block, assigns up to eight sub-blocks to per block, and assigns multiple blocks per page to one or more pages. In some embodiments, the medium access control logic comprises logic to generate the frame wherein the traffic indication map element comprises a traffic indication map parameter element and the frame comprises an association response frame. In some embodiments, the medium access control logic comprises logic to generate the frame wherein the traffic indication map element comprises a traffic indication map information element and the frame comprises a beacon frame. And in some embodiments of the apparatus, the medium access control logic comprises logic to generate the frame wherein the traffic indication map element comprises a traffic indication map information element and the frame comprises a bitmap control field, wherein the bitmap control field comprises a segment index field and a page index field, the segment index and the page index fields having lengths that vary in relation to the number of pages and the number of blocks.

Another example comprises a program product. The program product to generate a traffic indication map element may comprise a storage medium comprising instructions to be executed by a processor-based device, wherein the instructions, when executed by the processor-based device, perform operations, the operations comprising: a storage medium comprising instructions to be executed by a processor-based device, wherein the instructions, when executed by the processor-based device, perform operations, the operations comprising: determining, from a traffic indication map element, a value for a number of pages indicative of a hierarchical structure for a traffic indication map bitmap and a value for a number of blocks associated with each of the number of pages, which is indicative of the hierarchical structure for the traffic indication map bitmap.

Another example comprises a method. The method may involve receiving, by a medium access control logic of an associated station, a frame comprising a traffic indication map element, wherein the traffic indication map element comprises a value for a number of pages indicative of a hierarchical structure for a traffic indication map and a value for a number of blocks associated with each of the number of pages indicative of the hierarchical structure for the traffic indication map bitmap; and decoding, by the medium access control sublayer logic, the block control field of the traffic indication map to determine a content of the block.

In some embodiments, the method may further comprise decoding, by the medium access control sublayer logic, an updated number of pages and an updated number of blocks per page in a beacon frame. In some embodiments, parsing the traffic indication map element to determine the value for the number of pages indicative of the number of pages in the hierarchical structure for a traffic indication map bitmap and the value for the number of blocks associated with each of page. In many embodiments, parsing the traffic indication map element to determine a bitmap control field, wherein the bitmap control field comprises a segment index field and a page index field, the segment index and the page index fields having lengths that vary in relation to the number of pages and the number of blocks. In some embodiments, determining the lengths of the segment index and the page index fields based upon the number of pages and the number of blocks per page. In some embodiments, decoding comprises decoding an association response frame. And, in some embodiments, decoding comprises decoding a traffic indication map information element.

Another example comprises an apparatus. The apparatus may comprise a memory; a medium access control logic coupled with the memory to receive a frame comprising a traffic indication map element, wherein the traffic indication map element comprises a value for a number of pages indicative of a hierarchical structure for a traffic indication map bitmap and a value for a number of blocks associated with each of the number of pages indicative of the hierarchical structure for the traffic indication map bitmap.

In some embodiments, the apparatus further comprises a receiver coupled with the medium access control logic and an antenna to receive the frame. In some embodiments, the medium access control logic comprises logic to parse an updated number of pages and an updated number of blocks per page in memory and to generate a frame comprising the updated number of pages and the updated number of blocks per page. And, in some embodiments, the medium access control logic comprises logic to decode a traffic indication map parameter information element in an association response frame.

Another example comprises a program product. The program product to decode a traffic indication map element may comprise a medium containing instructions to generate a frame to indicate whether data is buffered by an access point for associated stations, wherein the instructions, when executed by the access point, causes the access point to perform operations, the operations comprising: determining, from a traffic indication map element, a value for a number of pages indicative of a hierarchical structure for a traffic indication map bitmap and a value for a number of blocks associated with each of the number of pages, which is indicative of the hierarchical structure for the traffic indication map bitmap.

In some embodiments of the program product, the operations further comprise decoding, by the medium access control sublayer logic, an updated number of pages and an updated number of blocks per page in a beacon frame. In some embodiments of the program product, parsing the traffic indication map element to determine a bitmap control field, wherein the bitmap control field comprises a segment index field and a page index field, the segment index and the page index fields having lengths that vary in relation to the number of pages and the number of blocks.

In some embodiments, some or all of the features described above and in the claims may be implemented in one embodiment. For instance, alternative features may be implemented as alternatives in an embodiment along with logic or selectable preference to determine which alternative to implement. Some embodiments with features that are not mutually exclusive may also include logic or a selectable preference to activate or deactivate one or more of the features. For instance, some features may be selected at the time of manufacture by including or removing a circuit pathway or transistor. Further features may be selected at the time of deployment or after deployment via logic or a selectable preference such as a dipswitch or the like. A user after via a selectable preference such as a software preference, an e-fuse, or the like may select still further features.

A number of embodiments may have one or more advantageous effects. For instance, some embodiments may offer reduced MAC header sizes with respect to standard MAC header sizes. Further embodiments may include one or more advantageous effects such as smaller packet sizes for more efficient transmission, lower power consumption due to less data traffic on both the transmitter and receiver sides of communications, less traffic conflicts, less latency awaiting transmission or receipt of packets, and the like.

Another embodiment is implemented as a program product for implementing systems, apparatuses, and methods described with reference to FIGS. 1-5. Embodiments can take the form of an entirely hardware embodiment, a software embodiment implemented via general purpose hardware such as one or more processors and memory, or an embodiment containing both specific-purpose hardware and software elements. One embodiment is implemented in software or code, which includes but is not limited to firmware, resident software, microcode, or other types of executable instructions.

Furthermore, embodiments can take the form of a computer program product accessible from a machine-accessible, computer-usable, or computer-readable medium providing program code for use by or in connection with a computer, mobile device, or any other instruction execution system. For the purposes of this description, a machine-accessible, computer-usable, or computer-readable medium is any apparatus or article of manufacture that can contain, store, communicate, propagate, or transport the program for use by or in connection with the instruction execution system or apparatus.

The medium may comprise an electronic, magnetic, optical, electromagnetic, or semiconductor system medium. Examples of a machine-accessible, computer-usable, or computer-readable medium include memory such as volatile memory and non-volatile memory. Memory may comprise, e.g., a semiconductor or solid-state memory like flash memory, magnetic tape, a removable computer diskette, a random access memory (RAM), a read-only memory (ROM), a rigid magnetic disk, and/or an optical disk. Current examples of optical disks include compact disk-read only memory (CD-ROM), compact disk-read/write memory (CD-R/W), digital video disk (DVD)-read only memory (DVD-ROM), DVD-random access memory (DVD-RAM), DVD-Recordable memory (DVD-R), and DVD-read/write memory (DVD-R/W).

An instruction execution system suitable for storing and/or executing program code may comprise at least one processor coupled directly or indirectly to memory through a system bus. The memory may comprise local memory employed during actual execution of the code, bulk storage such as dynamic random access memory (DRAM), and cache memories which provide temporary storage of at least some code in order to reduce the number of times code must be retrieved from bulk storage during execution.

Input/output or I/O devices (including but not limited to keyboards, displays, pointing devices, etc.) can be coupled to the instruction execution system either directly or through intervening I/O controllers. Network adapters may also be coupled to the instruction execution system to enable the instruction execution system to become coupled to other instruction execution systems or remote printers or storage devices through intervening private or public networks. Modem, Bluetooth™, Ethernet, Wi-Fi, and WiDi adapter cards are just a few of the currently available types of network adapters.

What is claimed is:

1. A method comprising:
generating, by a medium access control logic, a frame comprising a traffic indication map element, wherein the traffic indication map element comprises a value for a number of pages indicative of the number of pages in a hierarchical structure for a traffic indication map bitmap and a value for a number of blocks associated with each of the number of pages indicative of the number of blocks associated with each page in the hierarchical structure for the traffic indication map bitmap; and
encapsulating, by physical layer logic, the frame with a preamble to create a physical layer protocol data unit to transmit.

2. The method of claim 1, further comprising storing, by the medium access control sublayer logic, a traffic indication map in a memory in accordance with a hierarchical data structure, the hierarchical data structure comprises assignments of stations to sub-blocks, sub-blocks to one or more blocks, and the one or more blocks to one or more pages.

3. The method of claim 1, further comprising determining an updated number of pages and an updated number of blocks per page and generating a frame including the updated number of pages and the updated number of blocks per page.

4. The method of claim 1, wherein generating the frame comprises generating the traffic indication map element comprising a traffic indication map parameter element and the frame comprises an association response frame.

5. The method of claim 1, wherein generating the frame comprises generating the traffic indication map element comprising a traffic indication map information element and the frame comprises a beacon frame.

6. The method of claim 1, wherein generating the frame comprises generating the traffic indication map element comprising a traffic indication map information element and the frame comprising a bitmap control field, wherein the bitmap control field comprises a segment index field and a page index field, the segment index and the page index fields having lengths that vary in relation to the number of pages and the number of blocks.

7. A device comprising:
a memory;
a medium access control logic coupled with the memory to generate a frame comprising a traffic indication map element, wherein the traffic indication map element comprises a value for a number of pages indicative of a hierarchical structure for a traffic indication map bitmap and a value for a number of blocks associated with each of the number of pages indicative of the hierarchical structure for the traffic indication map bitmap.

8. The device of claim 7, further comprising a transmitter coupled with the medium access control logic and coupled with one or more antennas to transmit the frame.

9. The device of claim 7, wherein the medium access control logic comprises logic to determine an updated number of pages and an updated number of blocks per page and logic to generate a frame including the updated number of pages and the updated number of blocks per page.

10. The device of claim 7, wherein the medium access control logic is coupled with the memory to store a traffic indication map in the memory in accordance with a hierarchical data structure, wherein the hierarchical data structure assigns up to eight stations per sub-block, assigns up to eight sub-blocks to per block, and assigns multiple blocks per page to one or more pages.

11. The device of claim 7, wherein the medium access control logic comprises logic to generate the frame wherein the traffic indication map element comprises a traffic indication map parameter element and the frame comprises an association response frame.

12. The device of claim 7, wherein the medium access control logic comprises logic to generate the frame wherein the traffic indication map element comprises a traffic indication map information element and the frame comprises a beacon frame.

13. The device of claim 7, wherein the medium access control logic comprises logic to generate the frame wherein the traffic indication map element comprises a traffic indication map information element and the frame comprises a bitmap control field, wherein the bitmap control field comprises a segment index field and a page index field, the segment index and the page index fields having lengths that vary in relation to the number of pages and the number of blocks.

14. A method comprising:
receiving, by a medium access control logic of an associated station, a frame comprising a traffic indication map element, wherein the traffic indication map element comprises a value for a number of pages indicative of a hierarchical structure for a traffic indication map and a value for a number of blocks associated with each of the number of pages indicative of the hierarchical structure for the traffic indication map bitmap; and
decoding, by the medium access control sublayer logic, the block control field of the traffic indication map to determine a content of the block.

15. The method of claim 14, further comprising decoding, by the medium access control sublayer logic, an updated number of pages and an updated number of blocks per page in a beacon frame.

16. The method of claim 14, further comprising parsing the traffic indication map element to determine the value for the number of pages indicative of the number of pages in the hierarchical structure for a traffic indication map bitmap and the value for the number of blocks associated with each of page.

17. The method of claim 14, further comprising parsing the traffic indication map element to determine a bitmap control field, wherein the bitmap control field comprises a segment index field and a page index field, the segment index and the page index fields having lengths that vary in relation to the number of pages and the number of blocks.

18. The method of claim 17, further comprising determining the lengths of the segment index and the page index fields based upon the number of pages and the number of blocks per page.

19. The method of claim 14, wherein decoding comprises decoding an association response frame.

20. The method of claim 17, wherein decoding comprises decoding a traffic indication map information element.

21. A device comprising:
a memory;
a medium access control logic coupled with the memory to receive a frame comprising a traffic indication map element, wherein the traffic indication map element comprises a value for a number of pages indicative of a hierarchical structure for a traffic indication map bitmap and a value for a number of blocks associated with each of the number of pages indicative of the hierarchical structure for the traffic indication map bitmap.

22. The device of claim 21, further comprising a receiver coupled with the medium access control logic and an antenna to receive the frame.

23. The device of claim 21, wherein the medium access control logic comprises logic to parse an updated number of pages and an updated number of blocks per page in memory and to generate a frame comprising the updated number of pages and the updated number of blocks per page.

24. The device of claim 21, wherein the medium access control logic comprises logic to decode a traffic indication map parameter information element in an association response frame.

25. A machine-accessible product comprising:
a medium containing instructions to generate a frame to indicate whether data is buffered by an access point for associated stations, wherein the instructions, when executed by the access point, causes the access point to perform operations, the operations comprising:
generating a frame comprising a traffic indication map element, wherein the traffic indication map element comprises a value for a number of pages indicative of the number of pages in a hierarchical structure for a traffic indication map bitmap and a value for a number of blocks associated with each of the number of pages indicative of the number of blocks associated with each page in the hierarchical structure for the traffic indication map bitmap.

26. The machine accessible product of claim 25, wherein the operations further comprise determining an updated number of pages and an updated number of blocks per page and generating a frame including the updated number of pages and the updated number of blocks per page.

27. The machine accessible product of claim 25, wherein generating the frame comprises generating an association response frame comprising a traffic indication map parameter element and the frame comprises.

28. A machine-accessible product comprising:
a medium containing instructions to generate a frame to indicate whether data is buffered by an access point for associated stations, wherein the instructions, when executed by the access point, causes the access point to perform operations, the operations comprising:
determining, from a traffic indication map element, a value for a number of pages indicative of a hierarchical structure for a traffic indication map bitmap and a value for a number of blocks associated with each of the number of pages, which is indicative of the hierarchical structure for the traffic indication map bitmap.

29. The machine accessible product of claim 28, wherein the operations further comprise decoding, by the medium access control sublayer logic, an updated number of pages and an updated number of blocks per page in a beacon frame.

30. The machine accessible product of claim 29, wherein the operations further comprise parsing the traffic indication map element to determine a bitmap control field, wherein the bitmap control field comprises a segment index field and a page index field, the segment index and the page index fields having lengths that vary in relation to the number of pages and the number of blocks.
